(19) United States
(12) Patent Application Publication
(10) Pub. No.: US 2024/0390873 A1
(43) Pub. Date: Nov. 28, 2024

(54) MULTI-FUNCTIONAL CATALYTIC SORBENTS FOR HYDROGEN AND HYDROGEN-ENRICHED SYNGAS PRODUCTION FROM CARBON CONTAINING FEEDSTOCK

(71) Applicant: North Carolina State University, Raleigh, NC (US)

(72) Inventors: Fanxing LI, Raleigh, NC (US); Runxia CAI, Raleigh, NC (US); Mahe RUKH, Raleigh, NC (US); Leo BRODY, Raleigh, NC (US); Kunran YANG, Raleigh, NC (US)

(21) Appl. No.: 18/668,401

(22) Filed: May 20, 2024

Related U.S. Application Data
(60) Provisional application No. 63/503,508, filed on May 22, 2023.

(51) Int. Cl. B01J 8/26; B01J 8/18; B01J 20/06; B01J 20/28; B01J 23/34; B01J 23/92; B01J 35/40; B01J 38/30; C01B 3/44; C10J 3/72

(52) U.S. Cl. CPC B01J 8/26; B01J 8/1827; B01J 20/06; B01J 20/28004; B01J 23/34; B01J 23/92; B01J 35/40; B01J 38/30; C01B 3/44; C10J 3/721; C01B 2203/0233; C01B 2203/1041; C01B 2203/1241; C10J 2300/092; C10J 2300/0923; C10J 2300/093; C10J 2300/0946

(57) ABSTRACT

In one aspect, the disclosure relates to catalytic phase transfer sorbents (PTS) for producing hydrogen-enriched syngas from a carbonaceous feedstock, the PTS comprising a formula selected from ABO₃ and Aₙ₊₁BₙO₃ₙ₊₁, wherein A comprises one or more alkali metals or alkaline earth metals, wherein B comprises one or more transition metals, and wherein X comprises an anion. Also disclosed is a system for hydrogen generation from carbonaceous feedstocks, the system comprising a gasifier unit for production of H₂-rich syngas and a regenerator unit for regeneration of spent PTS. Further disclosed herein is a method for hydrogen generation from carbonaceous feedstocks using the disclosed systems. The disclosed systems can be operated isothermally through 10 or more cycles without degradation in performance, while the disclosed methods can yield 50% or more H₂ relative to carbon-containing species. In some aspects, the methods produce little to no CO₂.

### CROSS REFERENCE TO RELATED APPLICATIONS

This application claims the benefit of U.S. Provisional Application No. 63/503,508 filed on May 22, 2023, which is incorporated herein by reference in its entirety.

### STATEMENT REGARDING FEDERALLY SPONSORED RESEARCH OR DEVELOPMENT

This invention was made with government support under grant number DE-EE0008809 awarded by the U.S. Department of Energy. The government has certain rights in the invention.

### BACKGROUND

Efficient conversion of carbonaceous feedstocks, including biomass and biofuels, coal, shale gas, and municipal solid wastes to hydrogen or hydrogen-enriched syngas (CO+H₂) represents a promising route to address global climate change challenges, increase domestic energy supply, and effectively valorize low-value waste products. Conventional gasification and reforming approaches can convert a variety of carbonaceous fuels to syngas with high conversions. However, the formation of undesired CO₂ via the co-occurring water-gas-shift reaction lowers the H₂ concentration of the syngas stream. Therefore, significant energy- and cost-intensive syngas conditioning and downstream separation steps are required in order to improve the product gas quality.

Despite advances in syngas production research, there is still a scarcity of methods for syngas production offering high levels of hydrogen and low or no CO₂, that use a catalyst capable of regeneration, that are repeatable for numerous cycles, and that can operate isothermally or near isothermally. New catalysts for use in such methods, and systems for carrying out the methods, would also be desirable. These needs and other needs are satisfied by the present disclosure.

### SUMMARY

In accordance with the purpose(s) of the present disclosure, as embodied and broadly described herein, the disclosure, in one aspect, relates to catalytic phase transfer sorbents (PTS) for producing hydrogen-enriched syngas from a carbonaceous feedstock, the PTS comprising a formula selected from ABO₃ and Aₙ₊₁BₙO₃ₙ₊₁, wherein A comprises one or more alkali metals or alkaline earth metals, wherein B comprises one or more transition metals, and wherein X comprises an anion.

Also disclosed is a system for hydrogen generation from carbonaceous feedstocks, the system comprising: (a) a first reactor operating under a first oxygen partial pressure; (b) a second reactor operating under a second oxygen partial pressure; wherein the first reactor comprises a gasifier configured to receive a carbonaceous feedstock and steam; wherein the gasifier comprises a fluidized bed comprising the disclosed PTS; wherein the second reactor comprises a regenerator configured to receive air or another oxygen-containing gas and spent PTS from the first reactor; and wherein the regenerator regenerates the spent PTS and delivers it to the gasifier for reuse. In one aspect, the oxygen-containing gas can be from about 1% to about 100% (v/v) oxygen.

Further disclosed herein is a method for hydrogen generation from carbonaceous feedstocks, the method comprising: (a) injecting a carbonaceous feedstock into the first reactor of the disclosed system and flowing steam into the first reactor; (b) collecting conditioned syngas from the gasifier; (c) shuttling spent PTS to the regenerator; (d) regenerating the spent PTS with an oxygen-containing gas to create fresh PTS; and (e) shuttling the fresh PTS to the gasifier for reuse.

The disclosed systems can be operated isothermally through 10 or more cycles without degradation in performance, while the disclosed methods can yield 50% or more H₂ relative to carbon-containing species. In some aspects, the methods produce little to no CO₂.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows a schematic of reduction and decarbonation for perovskite-type catalysts as disclosed herein. FIG. 1B shows overall Gibbs energy change of absorption steps (a) and (b) (top left panel and top right panel, respectively) of exemplary sorbents as disclosed herein as a function of p_{O2}, p_{CO2}, and ΔG1⁰ at a temperature of 750° C. and a pressure of 1 atm and of regeneration steps (c) and (d) (bottom left panel and bottom right panel, respectively) of exemplary sorbents under the same conditions.

FIGS. 2A-2D show conversion by the disclosed methods of model compounds and/or tar in the absence (FIG. 2A) and presence (FIG. 2B) of a nickel-containing sorbent. Sorption capacity increased by 38% and a 98% toluene conversion was observed with an H₂:COₓ ratio of 3 or higher for all cycles.

FIGS. 3A-3B show exemplary reactors according to the present disclosure.

FIGS. 4A-4D show bi-functionality and tunability for an exemplary catalyst, including reproducibility of results over many cycles. FIG. 4E shows a comparison of reduction degree and CO₂ sorption for different catalysts.

FIGS. 5A-5B show demonstration of an exemplary sorbent in a packed bed including successful isothermal operation over at least 15 cycles.

FIGS. 6A-6B show stability of the disclosed sorbents in the presence of up to 25 wt % ash. It is noted that ash during operation of the gasifier is expected to be present only at about 0.03 wt %. FIG. 6A: 1 wt. % ash in sorbent: 29% CO₂ capacity vs. pure sorbent: 29.9%. FIG. 6B: 25 wt. % ash in sorbent: slight deactivation followed by stabilization.

FIGS. 7A-7B show a comparison between 0.3 g biomass injection (FIG. 7A) and 0.1 g biomass injection (FIG. 7B). Carbon balance was calculated based on the carbon species released under oxygen combustion conditions. No syngas or hydrogen was observed in the absence of a steam injection.

FIGS. 8A-8B show composition of selected sources of biomass useful in the disclosed methods.

FIGS. 9A-9B show results for a lab-scale fluidized bed reactor with 15 g of sorbent particles having an average diameter of 60 to 500 μm, or from about 180 to 425 μm, with injection of a woody biomass feedstock having particles of average diameter 200 to 500 μm, with biomass injection occurring by pressurized pneumatic transport in a batch mode and total fluidizing gas volume of 1.2 SLM and fluidizing velocity of 0.18 m/s. 100% carbon balance and carbon conversion were achieved with an H₂ concentration reaching 50-80% with minimal tar production. Higher CO₂ levels were observed for more oxidized sorbent under a batch mode of operation. Sorbent renderability and stability were achieved over 40 hours of fluidized bed operation.

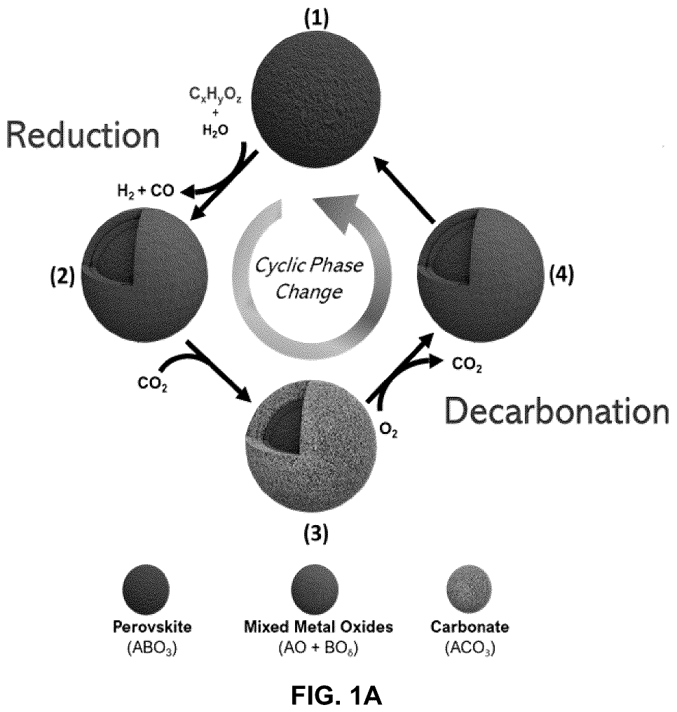

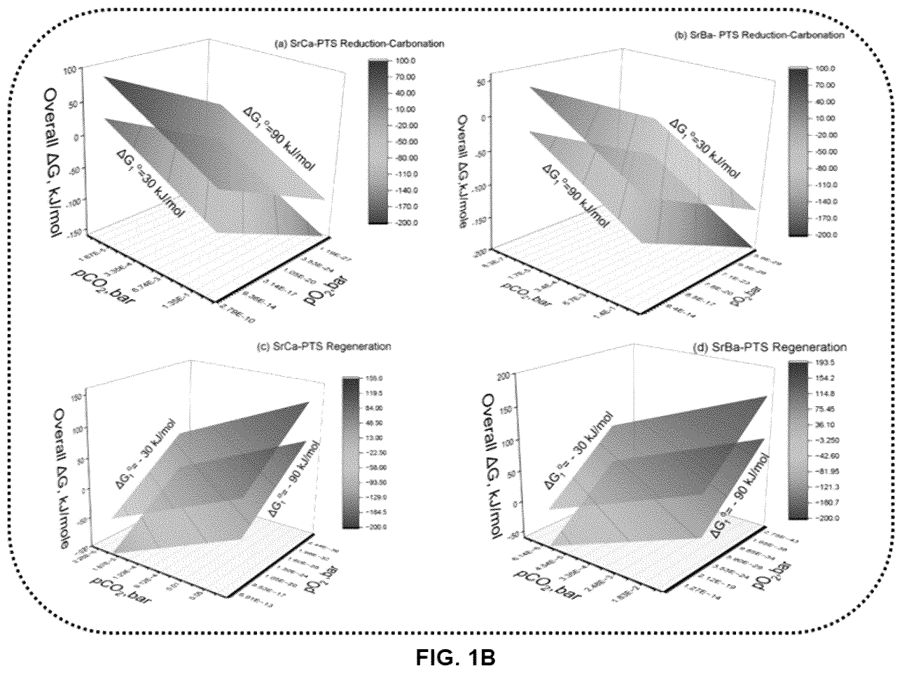

FIGS. 1A-10B show computational screening approach and results. FIG. 10A) Screening workflow for iSERG sorbents. The values above each arrow represent the count of perovskite structures that successfully passed the preceding screening step. FIG. 10B) Heatmaps of the thermodynamic descriptors of the 1225 candidates. The values of the x and y axes denote the concentrations of Sr and Fe in SrₓA₁₋ₓFe_{y}B_{1-y}O_{3-δ}, respectively.

FIGS. 11A-11C show experimental evaluation of the sorbents. FIG. 11A) Phase purity of the synthesized perovskites: different levels of grayscale in cells represent pure, nearly pure, and impure samples, respectively. FIG. 11B) CO₂ sorption capacities and FIG. 11C) oxygen capacities of pure and nearly pure materials measured in the TGA. The rightmost color bar represents the CO₂ capacity for FIG. 11B) and the O₂ capacity for FIG. 11C).

FIGS. 12A-12F show reactor performance results. Sorption-enhanced steam reforming of methane (FIGS. 12A-12B), sorption-enhanced steam reforming of biogas (FIGS. 12C-12D), sorption-enhanced steam reforming of biogas with partial regeneration (FIGS. 12E-12F)

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Disclosed herein are a new family of multi-functional catalytic sorbents and a process for hydrogen generation from carbonaceous feedstocks such as biomass, methane, and biogas. The disclosed material and process can greatly simplify the generation of hydrogen or hydrogen enriched syngas.

In one aspect, the multi-functional catalytic sorbent can be a phase transition sorbent (PTS) specifically addressing the shortcomings of state-of-the-art (SoA) technologies for sorption-enhanced gasification (SEG) of carbonaceous feedstocks to produce hydrogen-enriched syngas.

In a further aspect, the disclosed PTSs can offer excellent cyclic stability and catalytic activity and also achieve isothermal or near-isothermal operation. In a still further aspect, the novel PTS material can be synthesized as either the perovskite or Ruddlesden-Popper phase with general formulas of ABO₃ and Aₙ₊₁BₙO₃ₙ₊₁, respectively. In one aspect, the A-site elements can be alkaline metals and/or alkaline earth metals (e.g., Sr, Ca, Ba, La, Pr, K, Sm, or, in some aspects, La or Ce in combination with Sr, Ca, Ba, Sm, and/or K), and the B-site elements can be either solely transition metals (e.g., Fe, Co, Cu, Ni, Ti, Mn, Zr, Mg) or transition metals co-doped with Mg. In a further aspect, the typical process of SEG utilizing PTSs can be achieved using two interconnected reactors under different oxygen partial pressures. In the gasifier where the oxygen partial pressure is low, the biomass is gasified into raw syngas containing CO, CO₂, and H₂, using steam and lattice oxygen donation from the PTSs. In a further aspect, the sorbent is accordingly reduced and forms a mixture of reduced A-and B-site metals and metal oxides. In another aspect, and without wishing to be bound by theory, the exposed A-site metal oxides capture CO₂ and push the equilibrium of the water-gas-shift reaction to produce more H₂. Further in this aspect, the reduced B-site metals and metal oxides additionally catalyze the conversion of char and tar. In any of these aspects, the spent sorbents can be separated from the gaseous, hydrogen-enriched syngas product and can then be recirculated to the regenerator, which possesses a higher oxygen partial pressure. In one aspect, the reduced sorbent mixture can be both reoxidized and decarbonated to release CO₂. In one aspect, the SEG approach uses a simple, two-step process to replace SoA gasification, tar removal, syngas conditioning, and CO₂ separation steps, thereby greatly enhancing process efficiency and economics.

### Phase Transition Sorbents

In one aspect, disclosed herein is a catalytic phase transition sorbent (PTS) for producing hydrogen-enriched syngas from a carbonaceous feedstock, the PTS having a formula selected from ABO₃ and Aₙ₊₁BₙO₃ₙ₊₁, wherein A is selected from one or more alkali metals or alkaline earth metals, wherein B is selected from one or more transition metals, wherein n is 1, 2, or 3. In a further aspect, the PTS can be in a perovskite or Ruddlesden-Popper phase. In still another aspect, A can be selected from Sr, Ca, Ba, La, Sm, Pr, K, or any combination thereof. In a still further aspect, B can be selected from Mn, Co, Ni, Fe, Cu, Ti, Zr, Mg, or any combination thereof. In one aspect, when the PTS is SrFeO₃, Mg content may be required as a portion of B for isothermal operation. In one aspect, A can be greater than 60 atomic percent Sr and B can be greater than 60 atomic percent Mn. In another aspect, Ni-containing PTSs have a high sorption capacity. In another aspect, the PTS can have an average particle diameter of from about 60 to about 600 μm, or of about 60, 80, 100, 120, 140, 160, 180, 200, 220, 240, 260, 280, 300, 320, 340, 360, 380, 400, 450, 500, 550, or about 600 μm, or a combination of any of the foregoing values, or a range encompassing any of the foregoing values.

### Systems for Hydrogen Generation

Also disclosed herein is a system for hydrogen generation from carbonaceous feedstocks, the system including at least the following:
(a) a first reactor operating under a first oxygen partial pressure;
(b) a second reactor operating under a second oxygen partial pressure;
wherein the first reactor is or includes a gasifier configured to receive a carbonaceous feedstock and steam;
wherein the gasifier includes a fluidized bed comprising the disclosed PTS;
wherein the second reactor includes a regenerator configured to receive air or another oxygen-containing gas and spent PTS from the first reactor; and
wherein the regenerator regenerates the spent PTS and delivers it to the gasifier for reuse.

In one aspect, in the disclosed system, the second oxygen partial pressure is higher than the first oxygen partial pressure. In another aspect, the system operates isothermally or substantially isothermally. In one aspect, isothermal operation is conducted at from about 750° C. to about 980° C., or at about 850° C. In some aspects, the regenerator operates within ±300° C. of the gasifier.

### Methods for Hydrogen Generation

Furthermore, disclosed herein is a method for hydrogen generation from carbonaceous feedstocks, the method including at least the steps of:
(a) injecting a carbonaceous feedstock into the first reactor of the disclosed system and flowing steam into the first reactor;
(b) collecting conditioned syngas from the gasifier;
(c) shuttling spent PTS to the regenerator;
(d) regenerating the spent PTS to create fresh PTS; and
(e) shuttling the fresh PTS to the gasifier for reuse.

In a further aspect, the carbonaceous feedstock has a residence time in the gasifier of from about 20 to about 450 s, or of about 20, 80, 120, 250, or about 450 s, or a combination of any of the foregoing values, or a range encompassing any of the foregoing values. In one aspect, the method can be conducted at least 10 times before replacing the PTS. In any of these aspects, performance of the method is stable when the carbonaceous feedstock contains up to 25% (w/w) of ash.

In one aspect, a ratio between a feed rate of the carbonaceous feedstock and a PTS circulation rate is from about 1:1 to 1:150, or can be about 1:1, 1:5, 1:50, 1:100, or 1:150 on a weight basis. In one aspect, the carbonaceous feedstock can be woody biomass such as, for example, untreated southern yellow pine or wood treated with copper azole, creosote, or a flame retardant. In another aspect, the carbonaceous feedstock can be or include agricultural waste, food waste, municipal waste, biogas, landfill gas, waste plastic, natural gas, glycerol, coal, biomass pyrolysis oil, biomass pyrolysis gas, or any combination thereof. In a further aspect, the carbonaceous feedstock is made up of particles having an average diameter of from about 200 μm to 5 mm (5,000 μm), or of about 150, 300, 500, 1000, 1500, 2000, 2500, 3000, 3500, 4000, 4500, 5000 μm, or a combination of any of the foregoing values, or a range encompassing any of the foregoing values.

In one aspect, the PTS has a residence time in the gasifier of about 15 to about 600 s, or of about 15, 50, 100, 150, 200, 250, 300, 350, 400, 450, 500, 550, or about 600 s, or a combination of any of the foregoing values, or a range encompassing any of the foregoing values. In one aspect, the method produces conditioned syngas with an H₂ concentration of at least about 50%, about 60%, about 70%, or about 80% (v/v)., or produces conditioned syngas having an H₂ to CO ratio of at least 3:1, or both.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a sorbent,” “a carbonaceous feedstock,” or “an anion,” includes, but is not limited to, mixtures or combinations of two or more such sorbents, carbonaceous feedstocks, or anions, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a sorbent refers to an amount that is sufficient to achieve the desired improvement in the property modulated by the formulation component, e.g. achieving the desired level of feedstock conversion. The specific level in terms of wt % in a composition required as an effective amount will depend upon a variety of factors including the amount and type of biomass feedstock, reactor temperature, whether the reactor is operated in batch or continuous mode, and similar factors.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Lab-Scale Reactor Optimization

FIG. 1A shows a schematic of reduction and decarbonation for perovskite-type catalysts as disclosed herein. FIG. 1B shows overall Gibbs energy change of absorption steps (a) and (b) (top left panel and top right panel, respectively) of exemplary sorbents as disclosed herein as a function of p_{O2}, p_{CO2}, and ΔG1⁰ at a temperature of 750° C. and a pressure of 1 atm and of regeneration steps (c) and (d) (bottom left panel and bottom right panel, respectively) of exemplary sorbents under the same conditions.

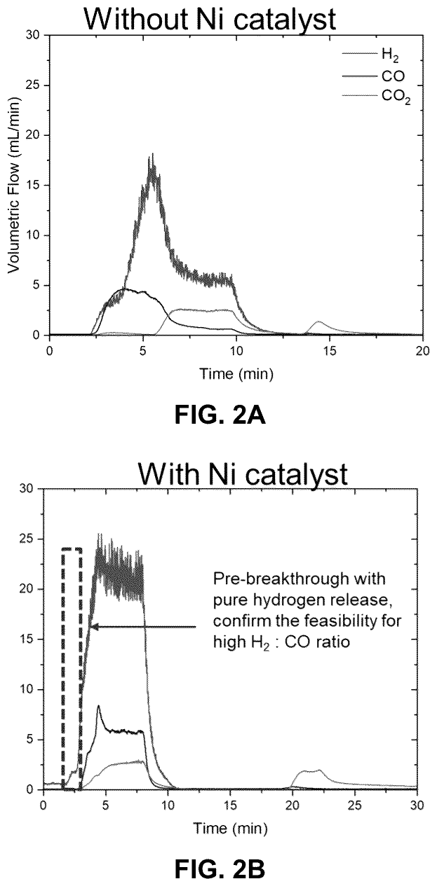

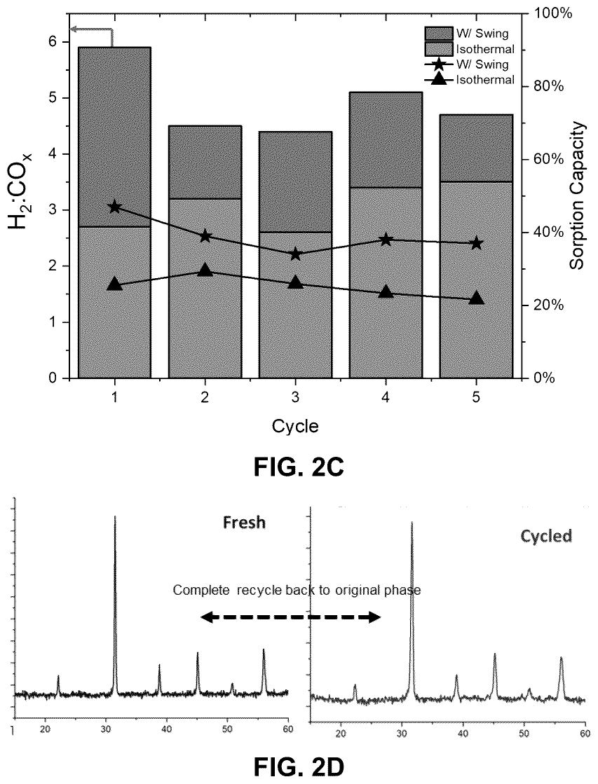

FIGS. 2A-2D show conversion by the disclosed methods of model compounds and/or tar in the absence (FIG. 2A) and presence (FIG. 2B) of a nickel-containing sorbent. Sorption capacity increased by 38% and a 98% toluene conversion was observed with an H₂:COₓ ratio of 3 or higher for all cycles.

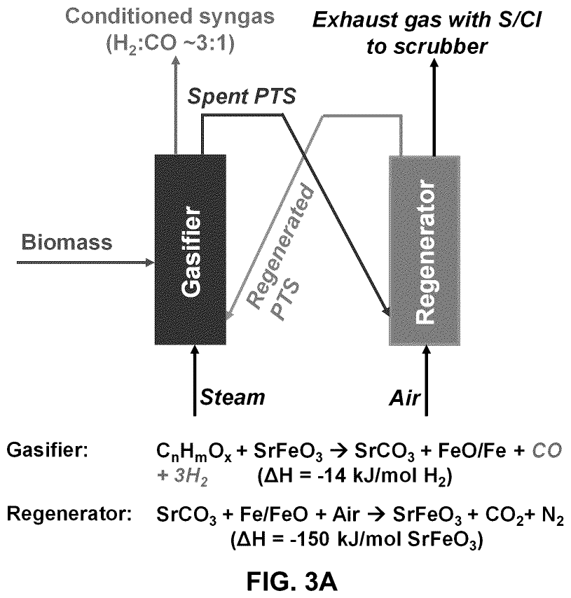

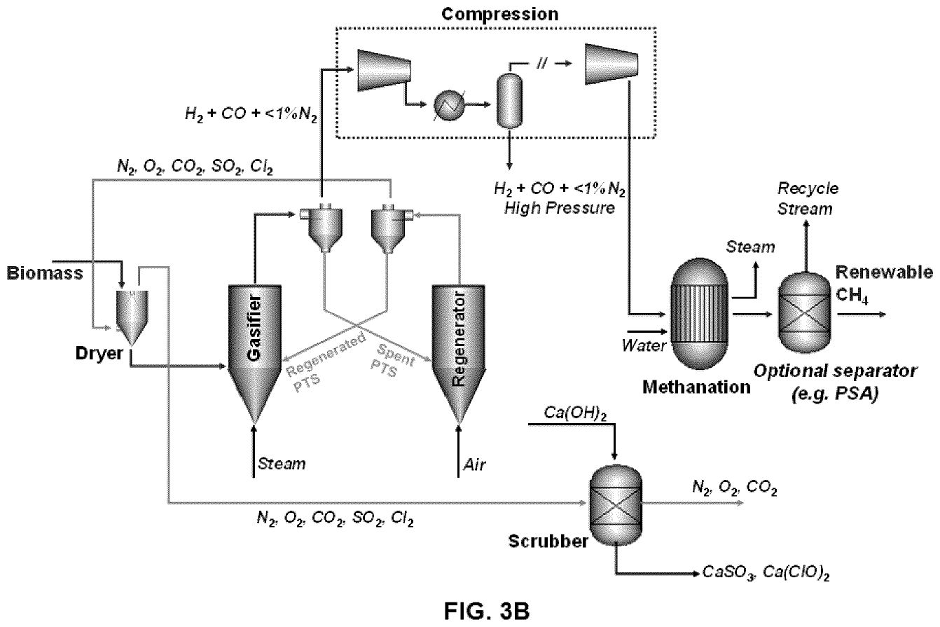

FIGS. 3A-3B show exemplary reactors according to the present disclosure.

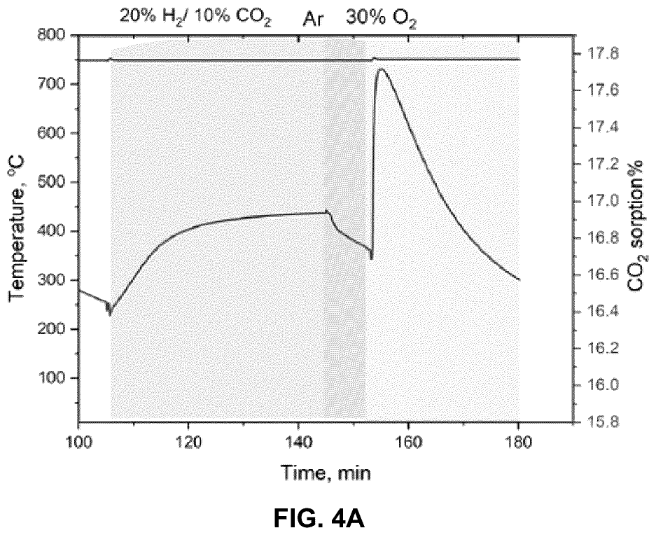

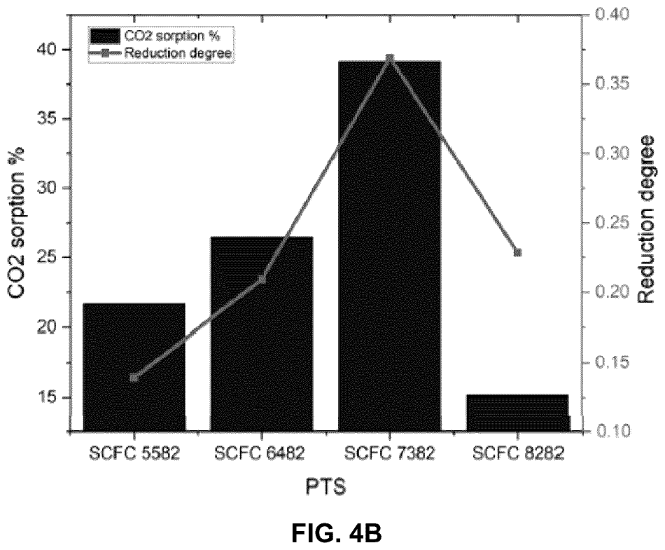

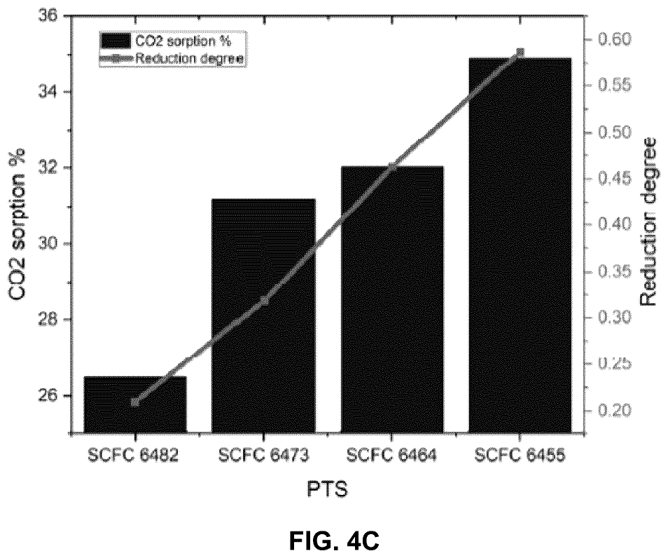

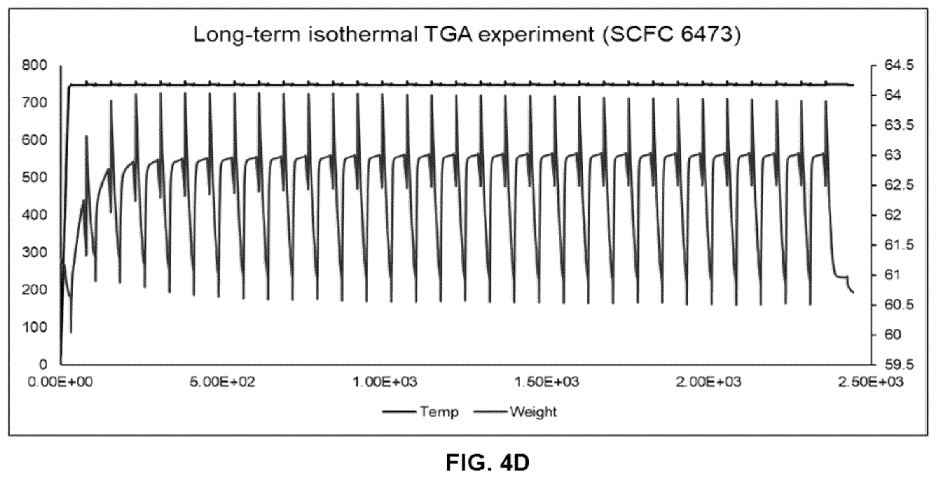

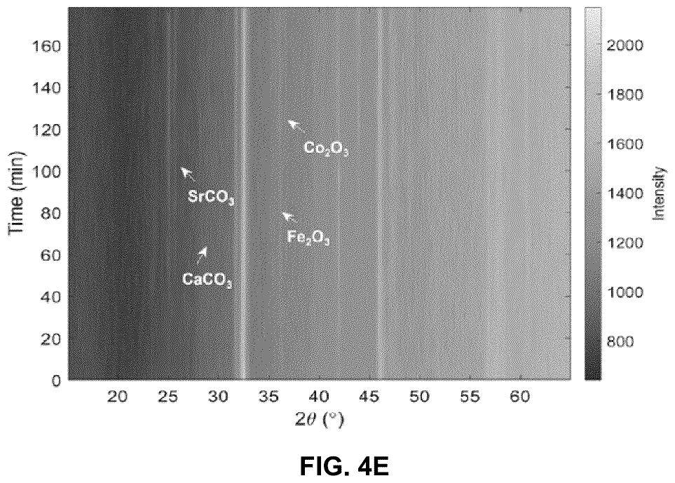

FIGS. 4A-4D show bi-functionality and tunability for an exemplary catalyst, including reproducibility of results over many cycles. FIG. 4E shows a comparison of reduction degree and CO₂ sorption for different catalysts.

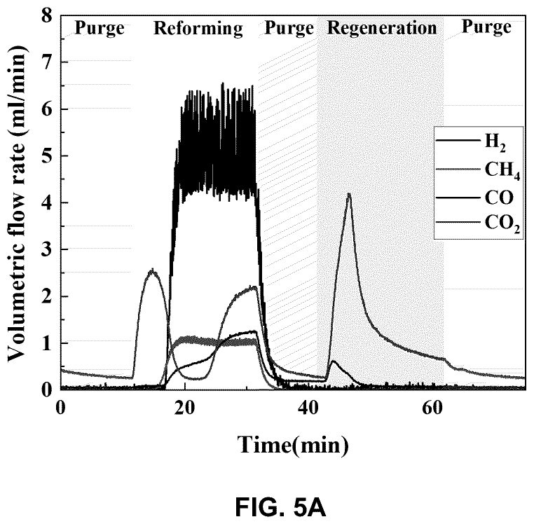

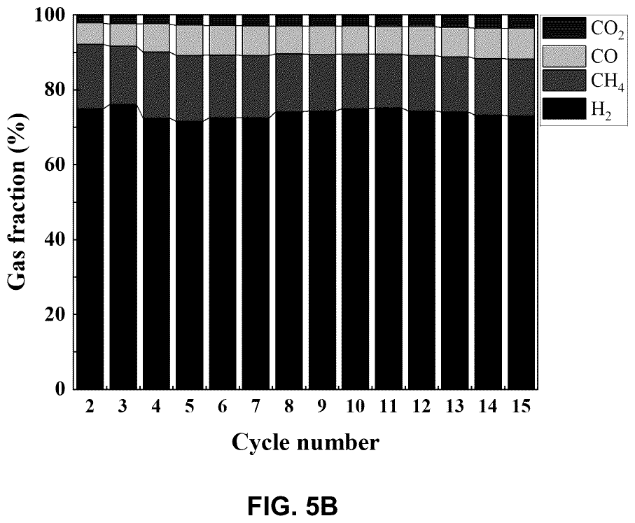

FIGS. 5A-5B show demonstration of an exemplary sorbent in a packed bed including successful isothermal operation over at least 15 cycles.

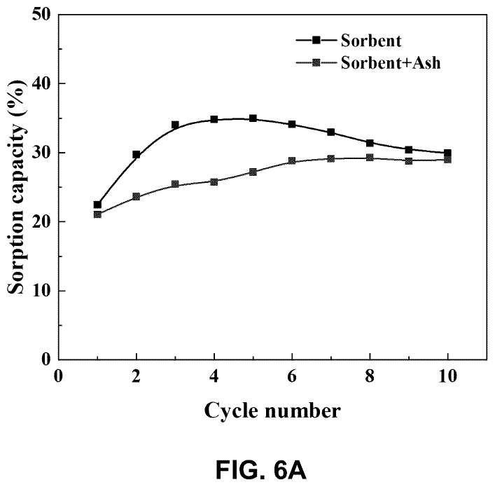

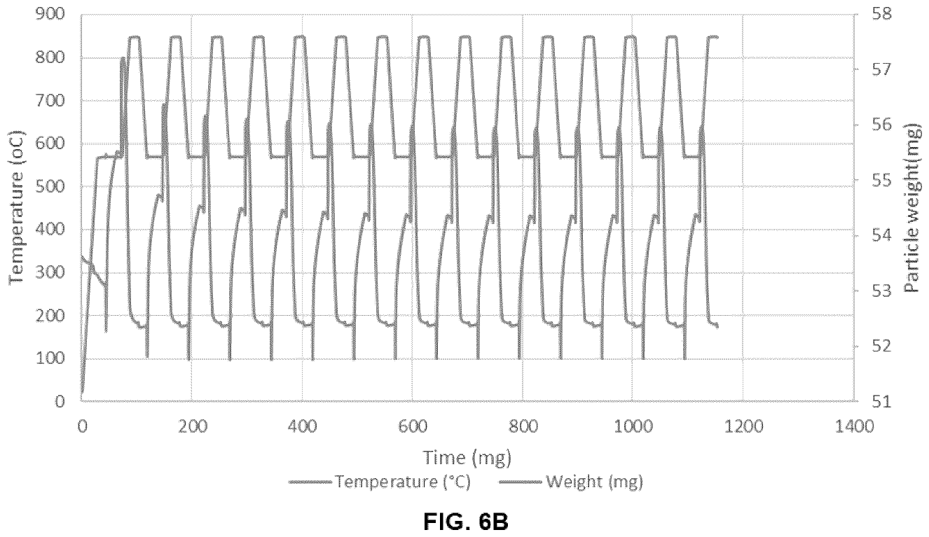

FIGS. 6A-6B show stability of the disclosed sorbents in the presence of up to 25 wt % ash. It is noted that ash during operation of the gasifier is expected to be present only at about 0.03 wt %. FIG. 6A: 1 wt. % ash in sorbent: 29% CO₂ capacity vs. pure sorbent: 29.9%. FIG. 6B: 25 wt. % ash in sorbent: slight deactivation followed by stabilization.

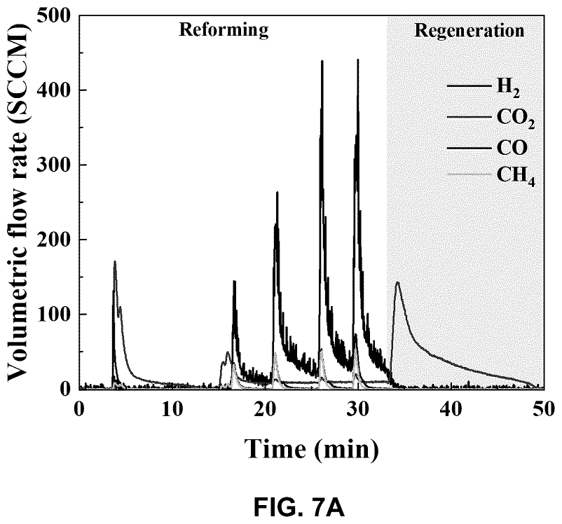

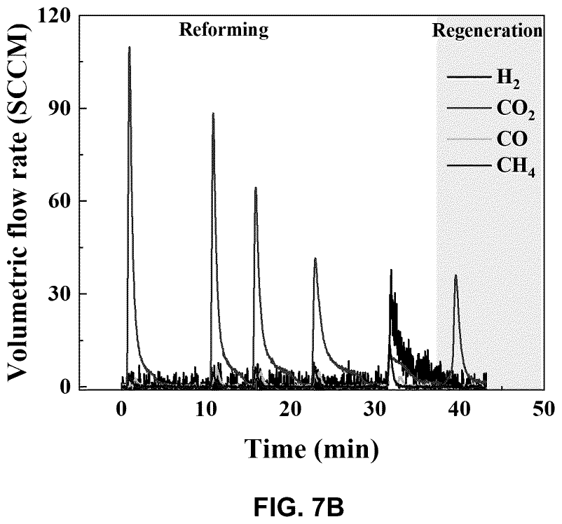

FIGS. 7A-7B show a comparison between 0.3 g biomass injection (FIG. 7A) and 0.1 g biomass injection (FIG. 7B). Carbon balance was calculated based on the carbon species released under oxygen combustion conditions. No syngas or hydrogen was observed in the absence of a steam injection.

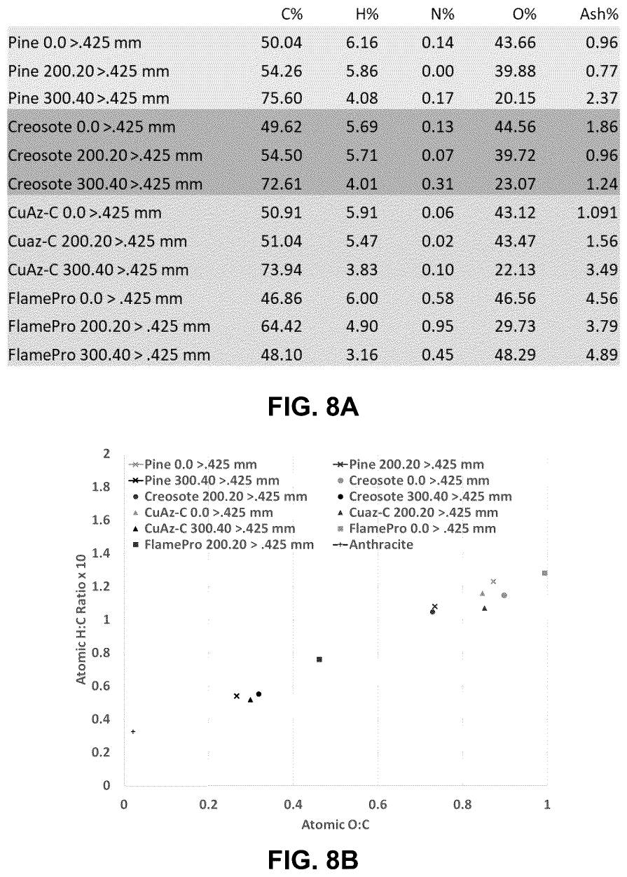

FIGS. 8A-8B show composition of selected sources of biomass useful in the disclosed methods.

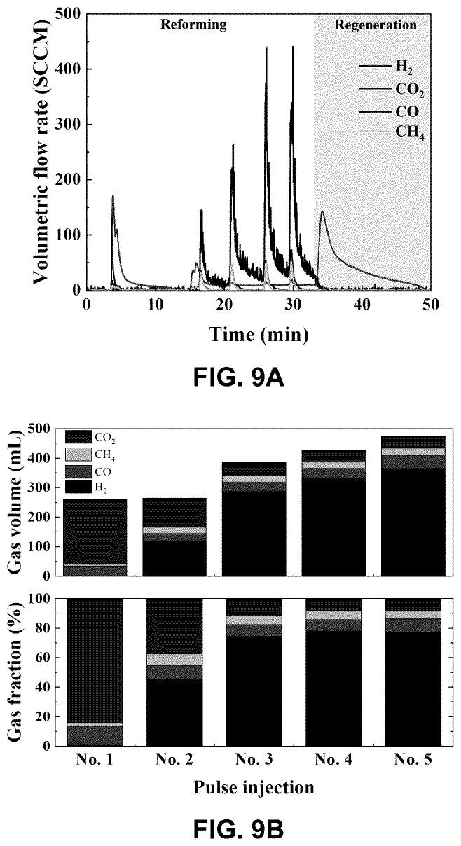

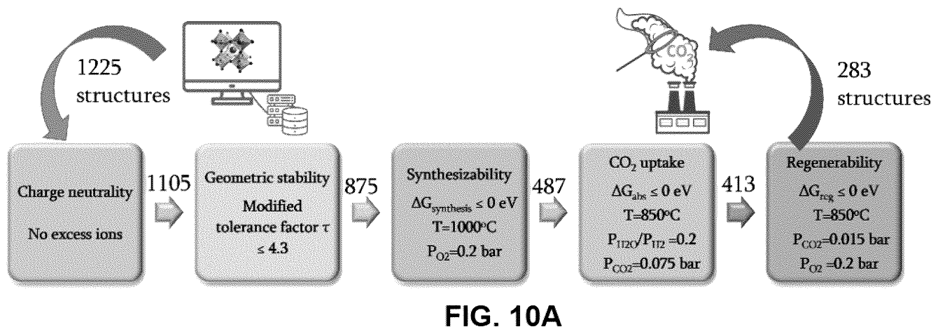

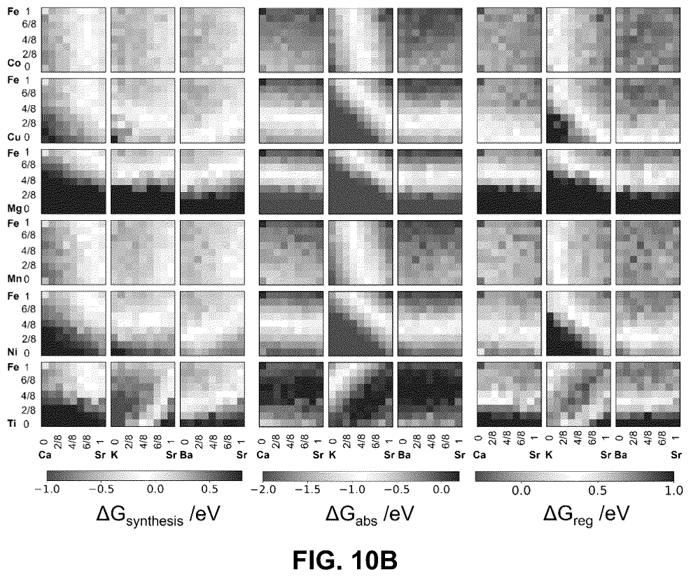

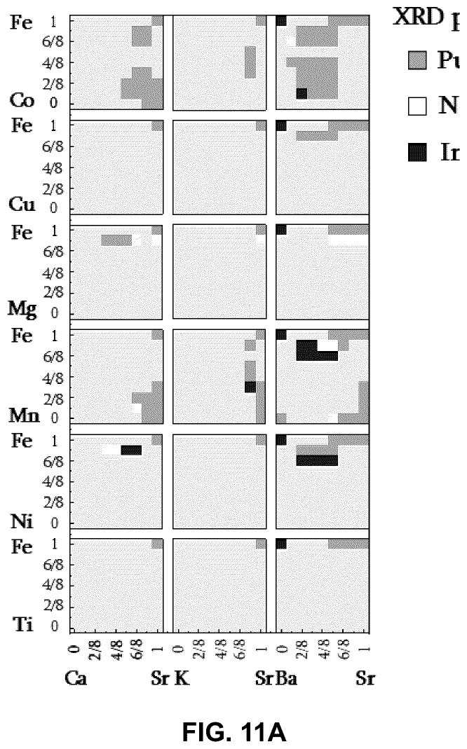

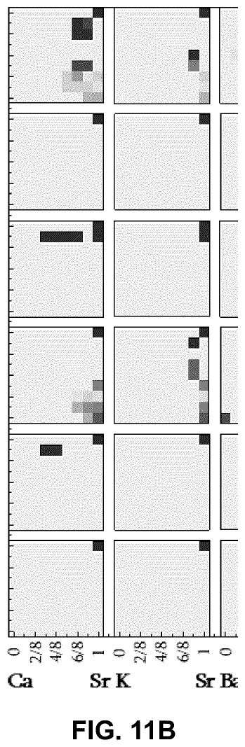

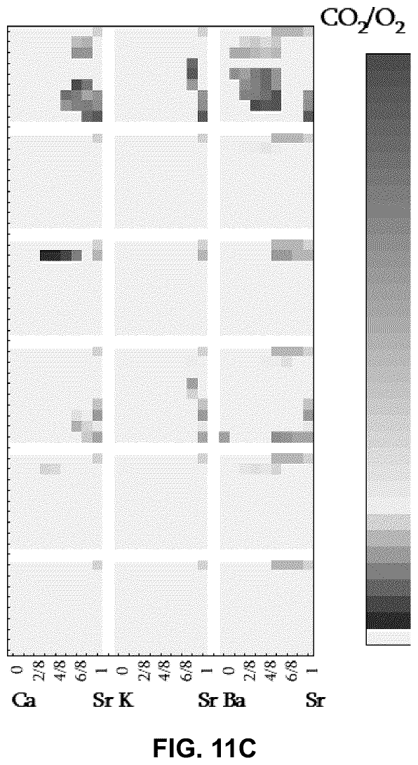

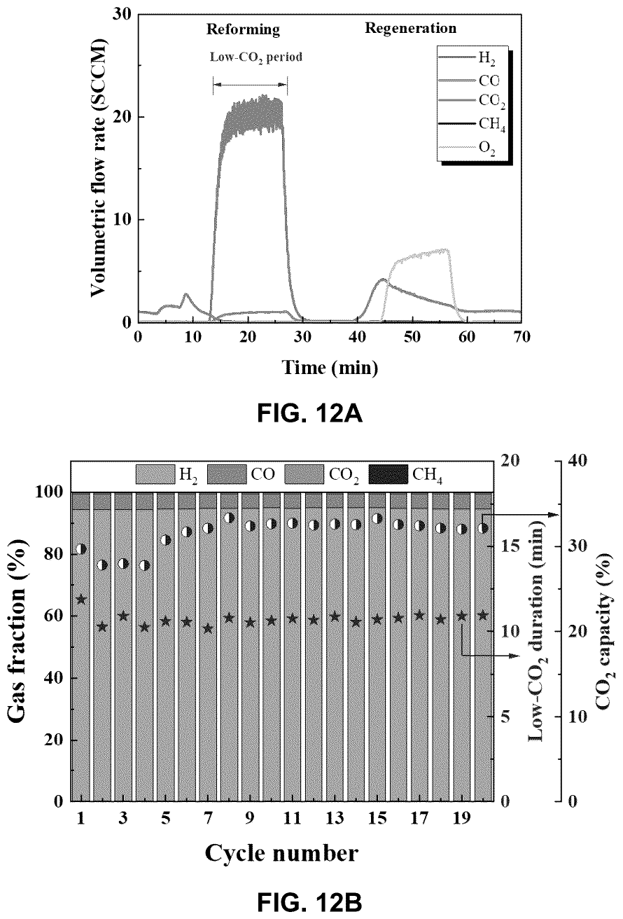

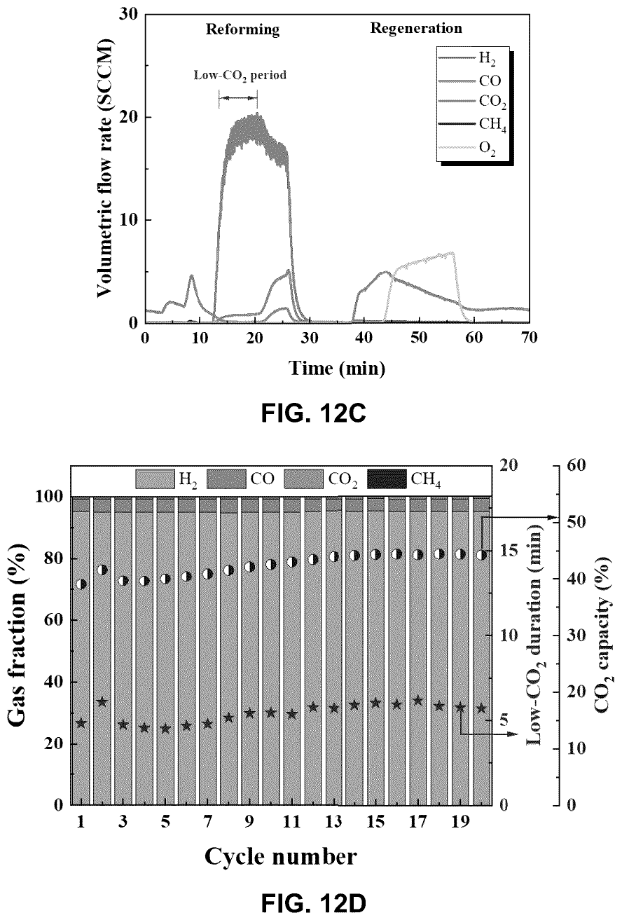

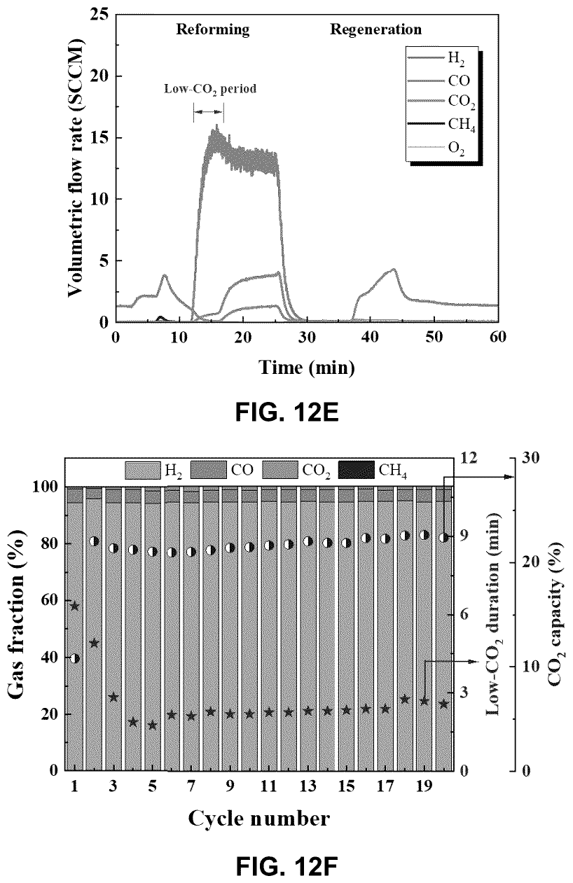

FIGS. 9A-9B show results for a lab-scale fluidized bed reactor with 15 g of sorbent particles having an average diameter of 180 to 425 μm, with injection of a woody biomass feedstock having particles of average diameter 200 to 500 μm, with biomass injection occurring by pressurized pneumatic transport in a batch mode and total fluidizing gas volume of 1.2 SLM and fluidizing velocity of 0.18 m/s. 100% carbon balance and carbon conversion were achieved with an H₂ concentration reaching 80% with minimal tar production. Higher CO₂ levels were observed for more oxidized sorbent under a batch mode of operation. Sorbent renderability and stability were achieved over 40 hours of fluidized bed operation.

### Example 2: Computational and Experimental Screening of Sorbent Performance

### Materials and Methods

DFT calculations: Density functional theory (DFT) calculations were conducted using VASP software. The projector-augmented wave (PAW) method was used to calculate the interaction between electrons and atomic cores. The generalized gradient approximation (GGA) approach combined with the PBE exchange-correlation functional was applied to calculate the electronic structure and corresponding energies. The cutoff energy was 450 eV. The energy threshold was set to 10⁻⁵ eV and the force threshold to 0.01 eV/Å. Here spin polarization effect was considered with the initial spin moments of Co, Fe, Mn and Ni to be 5, 4, 4 and 5, respectively. In addition, and the DFT+U method was utilized to give accurate description of the d electrons for Co, Cu, Fe, Mn, Ni and Ti with the effective Hubbard U values of 3.4, 4, 4, 3.9, 6 and 3 (unit in eV).

For A-site and B-site doping, the doping concentrations vary from 0 to 1 with an interval of 0.125, i.e., SrₓA₁₋ₓFe_{y}B_{1-y}O_{2.5} with x and y to be 0, 0.125, . . . , 0.875, and 1. By following the SQS structure generation algorithm, 1225 SrₓA₁₋ₓFe_{y}B_{1-y}O_{2.5} structures were obtained. In addition, vibrational calculations were further conducted for each structure and analyzed the results by using Phonopy. Similarly, calculations were performed on the metal oxides by the same procedures.

Thermodynamic calculations: A reaction generator was developed to balance the reaction stoichiometry for the Eqs. (1-3). The Gibbs free energies of the perovskite structures and other relevant species are obtained using the methods described herein. The transition between the perovskite phase and the brownmillerite phase is spontaneous under the reduction and oxidation conditions. Therefore, the brownmillerite structure was chosen as the initial state of Eq. (2) and the end state of Eq. (3) in thermodynamic analysis. This calculation approach is expected to provide more accurate results compared to using perovskites. To minimize the error arising from the inaccurate description of the free energies of species such as carbonates, experimental Gibbs free energies from HSC Chemistry software were utilized for solid reactions. These reactions include carbonation reactions (e.g., SrO+CO₂→SrCO₃) for Eq. 2, decarbonation reactions for Eq. 3, and hydrogen reduction to water for Eq. 2. The reaction free energy ΔG≤0 eV was used as the initial criteria for Eqs. (1-3). The energies of oxides, oxygen, etc. are from DFT calculations.

$$( 1 )$$

$$x SrO + \frac{1 - x}{m} {A}_{m} {O}_{n} + \frac{y}{2} {Fe}_{2} {O}_{3} + \frac{1 - y}{i} {B}_{i} {O}_{j} + {z}_{1} {O}_{2} \to {Sr}_{x} {A}_{1 - x} {Fe}_{y} {B}_{1 - y} {O}_{2.5}$$

$${Sr}_{x} {A}_{1 - x} {Fe}_{y} {B}_{1 - y} {O}_{2.5} + {CO}_{2} + {z}_{2} {H}_{2} \to {x SrCO}_{3} + \frac{1 - x}{m} {A}_{m} {CO}_{3} + \frac{y}{2} {Fe}_{2} {O}_{3} + \frac{1 - y}{i} {B}_{i} {O}_{j} + {z}_{2} {H}_{2} O \qquad ( 2 )$$

$${x SrCO}_{3} + \frac{1 - x}{m} {A}_{m} {CO}_{3} + \frac{y}{2} {Fe}_{2} {O}_{3} + \frac{1 - y}{i} {B}_{i} {O}_{j} + {z}_{3} {O}_{2} \to {Sr}_{x} {A}_{1 - x} {Fe}_{y} {B}_{1 - y} {O}_{2.5} + {CO}_{2} \qquad ( 3 )$$

The first thermodynamic screening step was aligned with typical perovskite synthesis conditions (1000° C. and P_{O2}=0.2 bar). FIG. 10B presents the heatmap displaying the ΔG_{syn} of all the structures. Notably, the stability of perovskites decreases with the increase in the doping concentrations of Cu, Mg, Ni, and Ti. However, this trend is not observed in samples doped with Co and Mn, making them more suitable for the SERG process due to their stability. A typical SERG temperature of 850° C. was selected as the reaction temperature of Eqs. 2 and 3. During the reduction/carbonation step, it is assumed that the system reaches equilibrium, with the partial pressure ratio P_{H2O}/P_{H2} set at 0.2 and P_{CO2} at 0.075 bar. During the regeneration step, the obtained mixed metal oxides and carbonates are expected to regenerate under oxidation conditions with P_{O2}=0.2 bar and P_{CO2}=0.015 bar.

Sample synthesis and characterization: The perovskite materials for both the screening and reactor experiments were prepared using a solid-state reaction method. For a typical synthesis of SrₓCa₁₋ₓFe_{y}Co_{1-y}O_{3-δ} for the screening experiment in the thermogravimetric analyzer (TGA), stoichiometric amounts of SrCO₃, CaCO₃, Fe₂O₃, and Co₃O₄ were added in a 5 mL Teflon vial and then mixed with 2 mm yttrium-stabilized ZrO₂ balls with a mass ratio of 1:5. 2˜3 mL ethanol (Fisher Scientific, CDA 19 (Histological)) was further added to the mixture to promote the mixing performance and reduce the particle size. A stainless-steel sample jar holding four vials with four different materials was balled milled at 1200 rpm for 3 h or 24 h using a high-energy ball mill (Vivtek Instrument: VBM-V80). The resulting wet slurry was dried in an oven at 95° C. for 30 min and 130° C. for another 30 min to remove ethanol. The dried powders were separated from ZrO₂ beads and then calcined at 1000° C. in a muffle furnace for 10 h to form the perovskite structure. The ramping rates for both heating and cooling steps were all set to 3° C./min. Several Mn-doped materials were subjected to calcination at 1200° C. in a tube furnace to improve the phase purity. The fresh perovskite sorbents were sieved to two desired particle size ranges, i.e., 180-250 μm for TGA experiments and 0-180 μm for XRD. A total of 100 different materials were synthesized for the screening experiments in the TGA. A large batch of SrMnO₃ was prepared for the reactor experiments. The precursors were mixed in two 150 mL and two 100 mL Teflon jars and ball-milled with 3 mm, 6 mm, and 10 mm ZrO balls and then milled at 250 rpm at a 45° angle for 12 h in a planetary ball mill (Columbia International, CIT-XBM4X-2.0L). The mixture of precursor powders after the drying step was first pelletized at 20 tons before calcined at 1100° C. in the muffle furnace. Afterwards, the resulting sorbent particles were sieved into a size of 180-425 μm. The rest of the synthesis procedures were the same as the screening study.

The precursors used in this study were SrCO₃ (Sigma Aldrich, >99.9%), CaCO₃ (Sigma Aldrich, >99%), BaO (Thermo Scientific, >99.5%), Co₃O₄ (Aldrich, >99%), Fe₂O₃(Noah Chemicals, >99.9%), MnO₂ (Materion, >99.9%), CuO (Noah Chemicals, >99%), KNO₃ (Noah Chemicals, >99%), NiO (Noah Chemicals, >99%), and MgO (Materion, >99.5%). The phase structures of the prepared fresh sorbents were characterized on a PANalytical X'Pert PRO X-ray diffraction (XRD) operating at 45 kV and 40 mA. The sample was scanned from 2θ of 15° to 80° with a step size of 0.0262° and a hold time of 0.2 s for each step. The analyses and identifications of the XRD phases of all the samples were accomplished using Highscore Plus software.

TGA preliminary screening for the CO₂/O₂ capacity: The sorption capacities of the pure and almost pure sorbents were measured in two TGAs (TA SDT Q650 and TA SDT Q600). To replicate the sorption-enhanced process of carbonaceous fuels, a 4-step cycle configuration was employed, consisting of a reduction step, a regeneration step, and two purge steps before each half-cycle. During the experiments, approximately 30˜50 mg of the fresh sorbents with a particle size of 180˜250 μm were loaded into the TGA and then heated to 850° C./at a ramping rate of 30° C./min under a flow of 140 SCCM Ar (Airgas UHP 5.0 grade). The gas flow rates were controlled using Alicat mass flow controllers (MC-series). Once the temperature reached 850° C./, the furnace was purged with Ar for 8 min to ensure a stable reaction temperature. Subsequently, an additional flow of 40 SCCM H₂ (Airgas UHP 5.0 grade) and 20 SCCM CO₂ (Airgas 4.0 grade) was injected for 30 min. The perovskite sorbents underwent reduction and captured CO₂, leading to a noticeable weight gain. The H₂ and CO₂ gas flows were then stopped, and the furnace was purged with pure Ar for 8 min. Some of the carbonates decomposed during this step. In the subsequent 20 min regeneration step, an additional 35 SCCM O₂ was injected. The reduced samples were initially re-oxidized and gained some weight in the first 1˜2 min, followed by the release of a significant amount of CO₂. Afterward, the first cycle was accomplished, and an identical second cycle was initiated. The CO₂ capacity was determined by measuring the weight changes in the second cycle. However, certain perovskites exhibited limited kinetics, preventing complete regeneration within the 20 min time frame. In order to ascertain the oxygen non-stoichiometry at the complete oxidation conditions, these perovskite materials were subjected to 850° C. under 20% O₂ atmosphere. Additionally, a reference point was established for each material by reducing the perovskite at 1100° C. in a 20% H₂ atmosphere, leading to a complete transformation to a mixture of pure metals and metal oxides. The CO₂ capacity was defined as the measured molar amount of CO₂ absorbed compared to the theoretical molar amount of CO₂ absorbed by A-site elements. The O₂ capacity was defined as the measured molar amount of released O atoms compared to the molar amount of the sorbent.

Sorption-enhanced steam reforming of methane and biogas in a packed bed: The sorption-enhanced steam reforming of methane and biogas was demonstrated in a quartz U-tube-packed bed with a 6 mm inner diameter. A sequential bed configuration was utilized to achieve a high methane conversion. 0.3 g of nickel-based steam reforming catalysts (Alfa Aesar, HiFUEL R110) was utilized in the upstream section, and 1.5 g of sorbents were employed in the downstream section. Both the catalyst and sorbent particles were sieved to a size range of 180 to 425 μm. Quartz wool and SiC were used as inert packing material to prevent blowout and preheat the inlet gas. The reactor was heated to 850° C. at a ramping rate of 30° C./min and then sustained at 850° C. throughout the entire experiment. A typical 4-step cycle configuration was also adopted, i.e., a 20 min purge step, a 20 min reduction step, another 10 min purge step, and a 20 min regeneration step. A flow of 30 SCCM Ar (Airgas UHP 5.0 grade) was maintained as the carrying gas throughout the entire cycle. For the methane reforming scenario, a flow of 5 SCCM CH₄ (Airgas UHP 5.0 grade) was introduced during the reduction step along with 7.35 μL/min of deionized water regulated by a syringe pump. This corresponded to a steam-to-carbon molar ratio of 2. For the biogas reforming scenario, a flow of 5 SCCM CH₄ (Airgas UHP 5.0 grade) was cofed with 2.5 SCCM CO₂ (Airgas UHP 4.5 grade) alongside the continuous infusion of 7.35 μL/min of deionized water. The water was injected 3 min prior to methane injection, ensuring a stable steam flow rate at the onset of the reduction step. During the regeneration step, 7.5 SCCM of O₂ (Airgas extra dry grade) was injected to create a 20% O₂ atmosphere.

To mitigate the less selective regime, another experiment was implemented with the incorporation of a pre-reduction step. The sample was pre-reduced with a gas mixture of 6 SCCM H₂ and 30 SCCM Ar for 10 min, followed by an Ar purge prior to the normal reaction cycle. Additionally, another experiment aimed at producing pure CO₂ without O₂ breakthrough for sequential carbon capture involved a shortened regeneration time. To control the reaction environment, 1.75 g sorbents, 4 SCCM of CH₄, 2.3 SCCM of CO₂, 5.88 μL/min of deionized water, and an 8 min regeneration time were utilized. The methane-to-carbon dioxide ratio was adjusted to match a typical biogas composition in the literature. Throughout these experiments, steam was condensed and separated downstream, and the remaining gaseous products were analyzed using an MKS Cirrus II quadrupole mass spectrometer (QMS). The reduced and regenerated samples from the biogas experiments were collected and tested using XRD to validate the reversibility for phase transition. Due to mass transfer limitations in the pack bed, the regenerated samples taken from the reactors were treated in TGA at 850° C. under a continuous flow of 40 SCCM O₂ and 160 SCCM Ar prior to XRD characterization.

### Results and Discussion:

High throughput computational screening: In all, 1225 sorbent compositions, with a general formula of SrₓA₁₋ₓFe_{y}B_{1-y}O_{3-δ} (A=Ca, K, or Ba and B=Mn, Ti, Co, Cu, Ni, or Mg), were considered in this study. The workflow for the computational screening is summarized in FIG. 10A. Initial steps in the workflow focus on ensuring the pre-requisites for the sorbent compositions, namely (i) charge neutrality and (ii) structural stability.

Firstly, the charge neutrality of various A and B-site cation combinations in the SrₓA₁₋ₓFe_{y}B_{1-y}O_{3-δ} structures were assessed. Out of the initial set, 120 compositions failing to satisfy the charge neutrality criterion were excluded from further consideration, with most of these containing a large fraction of Mg (≥50%). Subsequently, the structural stability of the remaining perovskite compositions was investigated using the modified tolerance factor (τ) proposed by Bartel et al., Derived from extensive data sets, this descriptor has demonstrated superior predictive capability for perovskite stability compared to the geometric-based Goldschmidt tolerance factor. A relaxed criterion of τ<4.3, was used to screen out 230 compositions that are likely to be unstable in a perovskite structure. Many of them contained a large fraction of K on the A-site and were shown to be unstable based on previous synthesis experience. These screening steps narrowed down the sorbent candidates to 875 compositions.

Beyond structural stability, a suitable perovskite sorbent for isothermal SERG must satisfy the following criteria:
(i) Synthesizability: the mixed oxide should be more stable than a simple mixture of its monometallic oxide precursors in an oxidizing environment (e.g., air);
(ii) Sorption capability: the sorbent should undergo spontaneous reduction and carbonation under a reducing environment and in the presence of CO₂;
(iii) Regenerability: the sorbent should spontaneously release CO₂ and reform the ABO_{3-δ} structure under an oxidizing environment.

The reactions corresponding to these criteria are listed below. Given the reducing atmosphere in the gasifier/reformer, a Brownmillerite phase with a general formula of ABO_{2.5} was considered in these reactions.

The Gibbs free energies of reactions 1-3, denoted as ΔG_{syn(thesis)}, ΔG_{abs(orption)}, and ΔG_{reg(eneration)}, respectively, are delineated in FIG. 10B for the 875 compositions under examination. To meet the screening criteria, these ΔGs should be ≤0 eV to ensure adequate thermodynamic driving forces. Applying this criterion, 283 compositions were identified as potentially suitable candidates for isothermal SERG operations. Computational details, based on a combination of DFT calculations of the perovskite oxides and the bulk thermodynamic properties of both the monometallic oxides and carbonates, are provided in the methodology section. Table 1 highlights several promising sorbent composition families. It is noted that over 90% of the SrBaFeCo and SrBaFeMn compositions were predicted to be favorable for iSERG. Therefore, this experimental investigation prioritized the SrBaFeCo and SrBaFeMn families of sorbents. Besides these compositions Sm and Pr doped sorbents also show promise.

TABLE 1
Promising composition families and the corresponding dopant
concentration ranges predicted by computational screening.

| Compositions | General dopant concentrations at A-site and B-site |
|---|---|
| SrBaFeMn | Ba: 0~1; Mn: 0~1 |
| SrBaFeCo | Ba: 0~1; Co: 0~1 |
| SrBaFeCu | Ba: 0~1; Cu: 0~0.5 |
| SrCaFeCo | Ca: 0~0.375; Co: 0~1 |
| SrBaFeNi | Ba: 0~1; Ni: 0~0.375 |

Experimental evaluation of sorbent isothermal performance: To assess the computational screening results, 100 sorbent compositions were prepared and characterized. Among these, 80 were deemed thermodynamically suitable for iSERG applications based on the computation results. X-ray diffraction (XRD) analyses revealed that 72 of the samples contained a single perovskite phase, while an additional 13 displayed minimal phase impurities. The remaining 15 samples presented at least one prominent secondary phase, although perovskite phase(s) were observed in all the samples. This confirms the effectiveness of computational screening in predicting the stability and synthesizability of the perovskite sorbents. Notably, most cobalt-containing materials, i.e., SrₓA₁₋ₓFe_{y}Co_{1-y}O_{3-δ}, were phase-pure. This may have resulted from the flexible valence states of Co and Fe as well as the similarities in ionic radii. On the other hand, Mn-doped materials tended to segregate into two distinct perovskite phases. Ni, Mg, and Cu-containing samples also tend to phase segregate when the doping level surpassed 12.5% (1/8) on the B-site, due to their instability at a valence state above 2+. It is noted that this model estimates phase stability and synthesizability based on the relative stability of perovskite and respective monometallic oxides (Reaction 1), it does not preclude the formation of alternative, more stable mixed oxide phases.

FIG. 10B displays the isothermal sorption capacities of the screened materials, defined as the percentage of A-site cations being reversibly carbonated, determined by thermogravimetric analysis (TGA). A relatively high operating temperature of 850° C. is chosen since it is commensurate with typical methane reforming and biomass gasification temperatures. This choice of operating temperature underscores an additional distinguishing feature of the redox-activated iSERG sorbents: whereas conventional sorbents are ineffective for CO₂ sorption at >700° C. due to thermodynamic constraints, the iSERG sorbents do not face this limitation. This thermodynamic flexibility allows them to maintain effectiveness in the conversion of biomass and biogas. In terms of sorbent performance, it was observed that calcium doping in the A-site reduced the CO₂ capacity, while barium doping resulted in an increase. This trend can be explained by the instability of CaCO₃ at 850° C., whereas BaCO₃ exhibits better stability than SrCO₃. Additionally, all samples with <25% B-site doping exhibited low sorption capacity, indicating that the B-site cation composition also plays a critical role in sorbent performance. This observation lends further credence to the proposed iSERG concept, emphasizing the link between the redox behavior of the B-site cations and the carbonation and decarbonation reactions. For instance, SrFeO_{3-δ} showed a negligible (˜0.13%) CO₂ sorption capacity, but upon doping the B-site with 75% Mn, the CO₂ capacity increased to 21%. Further increasing the Mn fraction to 87.5% boosted the CO₂ capacity to 59%. This finding aligns with DFT simulations, which revealed a decrease in ΔG_{abs} of 0.3 eV as Mn doping increased from 12.5% to 87.5%. More detailed fitting results unveiled robust correlations (R² between 0.7-0.9) between the dopant fractions of A-site and B-site elements and the CO₂ capacity. Additionally, doping the B-site with Ni, Mg, and Cu in amounts greater than 12.5% leads to phase segregation and are thus not suitable for iSERG.

Of all the samples tested, 21 perovskite oxides exhibited excellent sorption capacities (>35%). These high-performing sorbents primarily belong to three families: SrₓBa₁₋ₓFe_{y}Co_{1-y}O_{3-δ}, SrₓCa₁₋ₓFe_{y}Mn_{1-y}O_{3-δ}, and SrₓBa₁₋ₓFe_{y}Mn_{1-y}O_{3-δ}. Among these, Sr_{0.75}Ba_{0.25}MnO_{3-δ} registered the highest CO₂ capacity of 78%, closely followed by BaMnO_{3-δ} and SrMnO_{3-δ} with capacities of 77% and 75%, respectively. Within the tested SrₓBa₁₋ₓFe_{y}Co_{1-y}O_{3-δ} samples, Sr_{0.625}Ba_{0.375}Fe_{0.5}Co_{0.5}O_{3-δ} displayed the highest CO₂ capacity of ˜49%. Additionally, SrFeO_{3-δ} samples with elevated levels of cobalt doping also exhibited significant sorption capacities, such as SrCoO_{3-δ}, which had a CO₂ capacity of 40%. However, the cost of cobalt may limit their economic attractiveness.

In addition to the sorption capacity, the redox-based oxygen capacity, defined as the percentage of reducible lattice oxygen removed during the gasification/reforming step, is an important parameter for redox-activated sorbents. The oxygen capacity influences (i) the overall heat of reaction for the two-step process, as the redox reaction facilitates in-situ combustion of a fraction of the feedstock to counterbalance the endothermic gasification or reforming processes; and (ii) the distribution of reaction heat between the two steps. Specifically, the exothermic oxidation reaction would partially offset the heat required for carbonate decomposition, while the endothermic reduction reaction mitigates heat release during the carbonation reaction. Oxygen capacities for the screened materials are depicted in FIG. 11C.

Generally, within a specific sorbent family (e.g., SrxBa1-xFeyCo1-yO3-δ), compositions exhibiting higher sorption capacities also tend to have higher oxygen capacities. This relationship suggests a positive correlation between the carbonation and reduction reactions, aligning with the proposed iSERG concept. Oxygen capacities are also greatly influenced by both the type and levels of dopants at the B site. For instance, materials doped with cobalt generally exhibit greater oxygen capacity than other dopants. Increasing the B-site dopant level also significantly enhanced the oxygen capacities and reducibility of the sorbents. These distinctive characteristics provide a broad design space for choosing redox-activated CO₂ sorbents, allowing for the design of materials that optimally balance CO₂ sorption and redox properties, thereby improving iSERG performance.

Demonstration of isothermal hydrogen generation: Considering its simplicity, lower raw material cost, and relative ease of scalable synthesis, SrMnO₃ was selected for comprehensive performance evaluations. As shown in FIGS. 12A-12D, SrMnO₃ is highly effective for iSERG of various carbonaceous feedstocks, producing ˜95% pure H₂ from both biogas and methane with good cyclic stability. An additional attractive feature of the iSERG is its capability for integrated CO₂ capture. By modulating the duration of the regeneration step with the SrMnO₃ sorbent, pure CO₂ can be produced without a breakthrough of O₂ (FIGS. 12E-12F).

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A catalytic phase transition sorbent (PTS) for producing hydrogen-enriched syngas from a carbonaceous feedstock, the PTS comprising a formula selected from ABO₃ and Aₙ₊₁BₙO₃ₙ₊₁, wherein A comprises one or more alkali metals or alkaline earth metals, wherein B comprises one or more transition metals, wherein n is 1, 2, or 3.

2. The PTS of claim 1, wherein the PTS comprises a perovskite or Ruddlesden-Popper phase.

3. The PTS of claim 1, wherein A comprises Sr, Ca, Ba, La, Sm, Pr, K, or any combination thereof.

4. The PTS of claim 1, wherein B comprises Mn, Co, Ni, Fe, Cu, Ti, Zr, Mg, or any combination thereof.

5. The PTS of claim 1, wherein A comprises greater than 60 atomic percent Sr and B comprises greater than 60 atomic percent Mn.

6. The PTS of claim 1, wherein the PTS comprises an average particle diameter of from about 60 to about 600 μm.

7. A system for hydrogen or hydrogen enriched synthesis gas generation from carbonaceous feedstocks, the system comprising:
(a) a first reactor operating under a first oxygen partial pressure;
(b) a second reactor operating under a second oxygen partial pressure;
wherein the first reactor comprises a gasifier configured to receive a carbonaceous feedstock and steam;
wherein the gasifier comprises a fluidized bed comprising the PTS of claim 1;
wherein the second reactor comprises a regenerator configured to receive air or another oxygen-containing gas and spent PTS from the first reactor; and
wherein the regenerator regenerates the spent PTS and delivers it to the gasifier for reuse.

8. The system of claim 7, wherein the second oxygen partial pressure is higher than the first oxygen partial pressure.

9. The system of claim 7, wherein the system operates isothermally or substantially isothermally.

10. The system of claim 9, wherein operation is conducted at from about 750° C. to about 980° C.

11. The system of claim 10, wherein isothermal operation is conducted at about 850° C.

12. The system of claim 9, wherein the regenerator operates within ±300° C. of the gasifier.

13. A method for hydrogen or hydrogen enriched synthesis gas generation from carbonaceous feedstocks, the method comprising:
(a) injecting a carbonaceous feedstock into the first reactor of the system of claim 7 and flowing steam into the first reactor;
(b) collecting conditioned syngas from the gasifier;
(c) shuttling spent PTS to the regenerator;
(d) regenerating the spent PTS with an oxygen-containing gas to create fresh PTS; and
(e) shuttling the fresh PTS to the gasifier for reuse.

14. The method of claim 13, wherein the carbonaceous feedstock has a residence time in the gasifier of from about 20 to about 450 s.

15. The method of claim 13, wherein a ratio between a feed rate of the carbonaceous feedstock and a PTS circulation rate is from about 1:1 to 1:150 on a weight basis.

16. The method of claim 13, wherein the carbonaceous feedstock comprises woody biomass, agricultural waste, food waste, municipal waste, biogas, landfill gas, waste plastic, natural gas, glycerol, coal, biomass pyrolysis oil, biomass pyrolysis gas, or any combination thereof.

17. The method of claim 16, wherein the woody biomass comprises untreated southern yellow pine or wood treated with copper azole, creosote, or a flame retardant.

18. The method of claim 13, wherein the carbonaceous feedstock comprises particles having an average diameter of from about 200 to about 5000 μm.

19. The method of claim 13, wherein the PTS has a residence time in the gasifier of from about 15 to about 600 s.

20. The method of claim 13, wherein the method produces conditioned syngas with an H₂ concentration of at least about 50% (v/v).
